(19) United States
(12) Patent Application Publication
(10) Pub. No.: US 2025/0123447 A1
(43) Pub. Date: Apr. 17, 2025

(54) SEMICONDUCTOR PACKAGE WITH PHOTONIC CHIP

(71) Applicant: SAMSUNG ELECTRONICS CO., LTD., Suwon-si (KR)

(72) Inventors: Junghoon Kang, Suwon-si (KR); Daegon Kim, Suwon-si (KR)

(21) Appl. No.: 18/787,653

(22) Filed: Jul. 29, 2024

(30) Foreign Application Priority Data
Oct. 16, 2023 (KR) 10-2023-0137976

(51) Int. Cl. G02B 6/42

(52) U.S. Cl. CPC G02B 6/4206

(57) ABSTRACT

Provided is a semiconductor package including a package substrate and a photonic integrated circuit chip arranged on the package substrate, having a groove extending from a lateral surface of the photonic integrated circuit chip to the inside of the photonic integrated circuit chip, and including a photoelectric converter, wherein the photoelectric converter includes a light-emitting device configured to generate an optical signal, a first waveguide connected to the light-emitting device and providing a path through which the optical signal travels, a first grating coupler configured to output the optical signal, a second waveguide connected to first grating coupler, and a tunable coupler connected to the first waveguide and the second waveguide.

### CROSS-REFERENCE TO RELATED APPLICATION

This application claims priority under 35 U.S.C. § 119 to Korean Patent Application No. 10-2023-0137976, filed on Oct. 16, 2023, in the Korean Intellectual Property Office, the disclosure of which is incorporated by reference herein in its entirety.

### BACKGROUND

Aspects of this disclosure relate to semiconductor packages including photonic integrated circuit chips.

Semiconductor packages have been actively used to improve performance of electronic devices and to integrate components with one another. Semiconductor packages facilitate mounting of various integrated circuits such as a memory chip, a logic chip, etc., on a package substrate. In a context in which data traffic increases in data centers and communication infrastructures, development of semiconductor packages has continued.

### SUMMARY

Some aspects of this disclosure describe semiconductor packages that provide improved integration.

According to some implementations, there is provided a semiconductor package including a package substrate and a photonic integrated circuit chip arranged on the package substrate, having a groove extending from a lateral surface of the photonic integrated circuit chip to the inside of the photonic integrated circuit chip, and including a photoelectric converter, wherein the photoelectric converter includes a light-emitting device configured to generate an optical signal, a first waveguide connected to the light-emitting device and providing a path through which the optical signal travels, a first grating coupler configured to output the optical signal, a second waveguide connected to first grating coupler, and a tunable coupler connected to the first waveguide and the second waveguide.

According to some implementations, there is provided a semiconductor package including a package substrate and a photonic integrated circuit chip arranged on the package substrate, having a groove extending from a lateral surface of the photonic integrated circuit chip to the inside of the photonic integrated circuit chip, and including a photoelectric converter including a photonic integrated circuit (PIC) transmitter and a PIC receiver, wherein the PIC transmitter includes a transmitter edge coupler arranged on a lateral portion of the photonic integrated circuit chip, a light-emitting device configured to convert a first electric signal into a first optical signal, a transmitter grating coupler configured to output the first optical signal, and a transmitter tunable coupler configured to couple the first optical signal received from the light-emitting device and transmit the coupled first optical signal to the transmitter grating coupler, and wherein the PIC receiver includes a receiver edge coupler arranged on the lateral portion of the photonic integrated circuit chip, a receiver grating coupler configured to input a second optical signal, a photodiode configured to convert the second optical signal into a second electric signal, and a receiver tunable coupler configured to couple the second optical signal received from the receiver grating coupler and transmit the coupled second optical signal to the photodiode.

According to some implementations, there is provided a semiconductor package including a package substrate and a photonic integrated circuit chip arranged on the package substrate, having a groove extending from a lateral surface of the photonic integrated circuit chip to the inside of the photonic integrated circuit chip, and including a photoelectric converter including a PIC transmitter and a PIC receiver, wherein the PIC transmitter includes a light-emitting device configured to convert a first electric signal into a first optical signal, a first waveguide connected to the light-emitting device and providing a path through which the first optical signal travels, a first transmitter grating coupler configured to output the first optical signal, a second waveguide including a first end connected to the first transmitter grating coupler, and a transmitter tunable coupler configured to couple the first optical signal received from the first waveguide and transmit the coupled first optical signal to the second waveguide, and the PIC receiver includes a first receiver grating coupler configured to input a second optical signal, a third waveguide including a second end connected to the first receiver grating coupler and providing a path through which the second optical signal travels, a photodiode configured to convert the second optical signal into a second electric signal, a fourth waveguide connected to the photodiode and providing a path through which the second optical signal travels, and a receiver tunable coupler configured to couple the second optical signal received from the third waveguide and transmit the coupled second optical signal to the fourth waveguide.

### BRIEF DESCRIPTION OF THE DRAWINGS

Implementations will be more clearly understood from the following detailed description taken in conjunction with the accompanying drawings in which:

FIG. 1 is a perspective view of semiconductor packages arranged on a wafer according to some implementations;

FIG. 2 is a perspective view of a semiconductor package according to some implementations;

FIG. 3 is a plan view of a semiconductor package according to some implementations;

FIG. 4 is a cross-sectional view taken along the line A-A′ of FIG. 3;

FIG. 5 is a cross-sectional view taken along the line B-B′ of FIG. 3;

FIG. 6 is an enlarged view of the EX region of FIG. 5;

FIG. 7 is a plan view schematically illustrating a photoelectric converter according to some implementations;

FIGS. 8 and 9 are diagrams schematically illustrating an operating process of a photoelectric converter;

FIG. 10 is a plan view schematically illustrating a photoelectric converter according to some implementations; and

FIG. 11 is a diagram schematically illustrating an operating process of the photoelectric converter illustrated in FIG. 10.

### DETAILED DESCRIPTION

Hereinafter, examples according to the present disclosure are described in detail with reference to the attached drawings. However, the scope of this disclosure is not limited to the examples described below, and the disclosure may be embodied in various forms.

A semiconductor package according some implementations may include an electronic integrated circuit chip transmitting/receiving an electric signal and a photonic integrated circuit chip including couplers coupling an optical signal. The photonic integrated circuit chip may include a grating coupler configured to couple an optical signal from the outside and a tunable coupler configured to couple an optical signal transmitted through the grating coupler.

Accordingly, even when an optical fiber unit is not arranged to face an edge coupler arranged on a lateral portion of a photonic integrated circuit chip in an optical signal test process, by using the grating coupler and the tunable coupler, transmission of optical signals by waveguides in the photonic integrated circuit chip may be tested.

When the optical fiber unit is arranged to face the edge coupler for an optical signal test of the semiconductor packages arranged on a wafer, the optical fiber unit takes up a large space on a main surface of the wafer, which leads to decreased productivity in manufacturing of semiconductor packages. In some implementations of the semiconductor package described herein, as an optical fiber unit for an optical signal test is not on a lateral portion of a photonic integrated circuit chip, more semiconductor packages may be arranged on one wafer and the manufacturing efficiency may increase.

However, the effects of the features described herein are not limited to the effects described above, and unmentioned advantages will be clearly understood by one of ordinary skill in the art from the specification and the accompanying drawings.

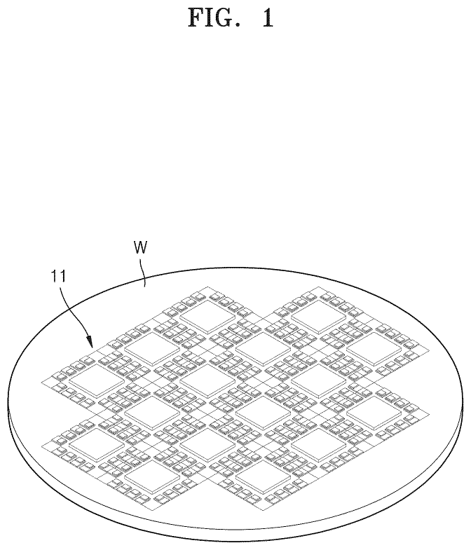

FIG. 1 is a perspective view of semiconductor packages 11 arranged on a wafer W according to some implementations.

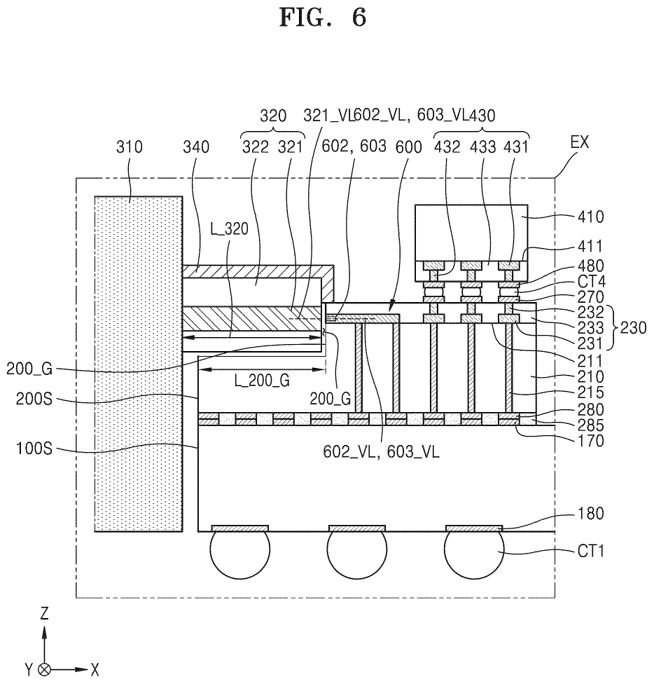

The semiconductor package 11 illustrated in FIG. 1 may be a package before being separated from the wafer W and may not include (e.g., may not yet include) an optical fiber unit 300 facing an edge coupler 225 (e.g., as shown in FIG. 6).

As illustrated in FIG. 1, the plurality of semiconductor packages 11 may be arranged on a front surface of the wafer W. The semiconductor packages 11 may be manufactured through various processes on a front surface of the wafer W.

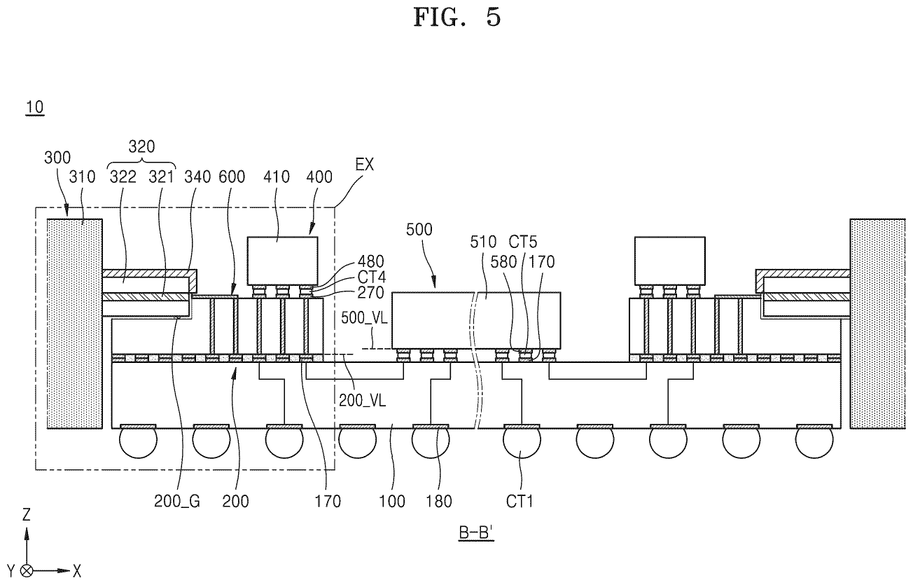

As described below, the semiconductor package 11 according to some implementations may undergo an optical signal test process before singulation on the wafer W. The optical signal test process may be a process to examine whether an optical signal is properly output when an electric signal is input from the outside of the semiconductor package 11 including a photoelectric converter 600 (e.g., as shown in FIG. 5), and/or whether an electric signal is properly output when an optical signal is input from the outside of the semiconductor package 11.

In an example of an optical signal test process, referring to FIG. 6, the optical fiber unit 300 may be arranged to face edge couplers 602 and 603 (i.e., a transmitter edge coupler 602 and a receiver edge coupler 603) arranged on a lateral portion of the semiconductor package 11 arranged on the wafer W, and an optical signal may be input thereto. When the optical fiber unit 300 is arranged to face the edge couplers 602 and 603 and an optical signal is input thereto, an area on the wafer W is dedicated to the optical fiber unit 300, which may cause limitation in the number of semiconductor packages 11 that may be arranged on one wafer W. Accordingly, as the optical signal test process performed on the semiconductor package 11 according to some implementations is performed without arranging the optical fiber unit 300 to face the edge couplers 602 and 603, a space on the wafer W, in which more semiconductor packages 11 may be arranged, may be secured.

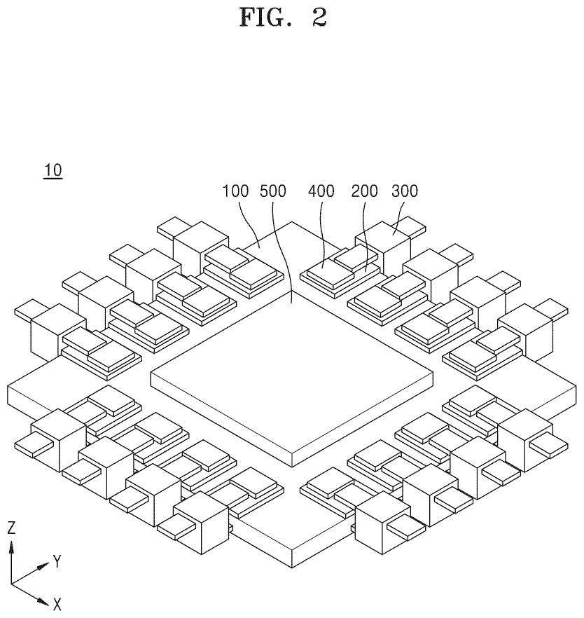

FIG. 2 is a perspective view of a semiconductor package 10 according to some implementations. The semiconductor package 10 illustrated in FIG. 2 may be a semiconductor package after being separated from the wafer W through the singulation and may include the optical fiber unit 300 facing the edge couplers 602 and 603 arranged on the lateral portion.

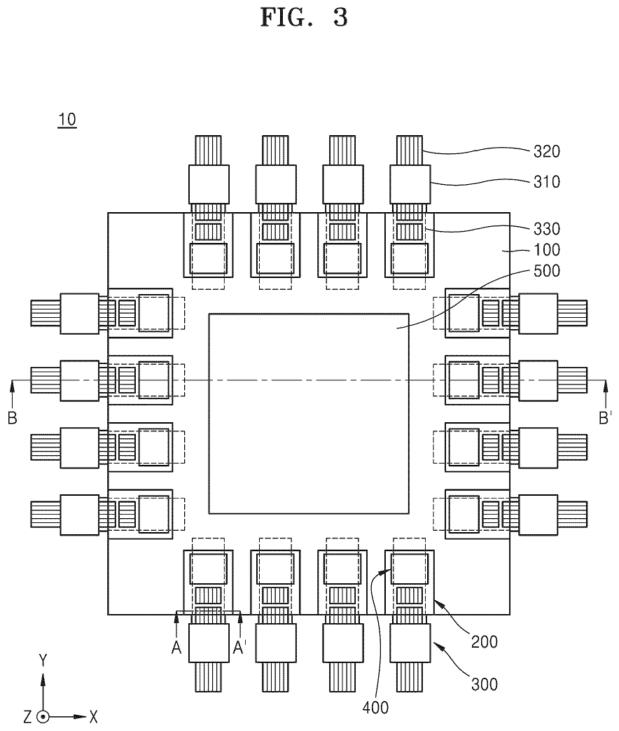

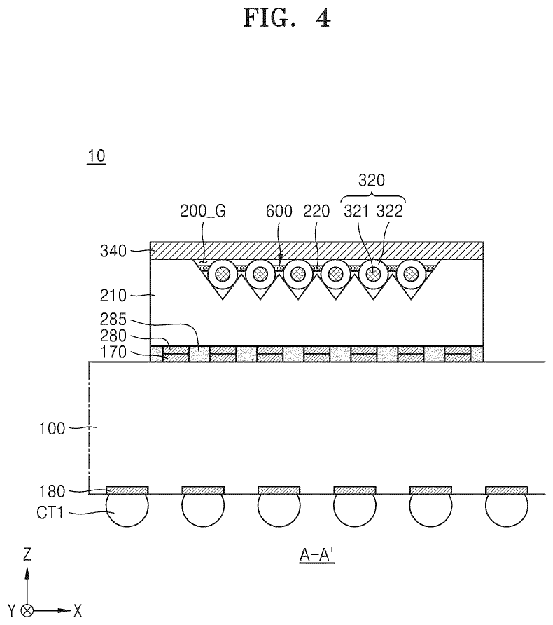

FIG. 3 is a plan view of a semiconductor package according to some implementations. FIG. 4 is a cross-sectional view taken along the line A-A′ of FIG. 3, and FIG. 5 is a cross-sectional view taken along the line B-B′ of FIG. 3. FIG. 6 is an enlarged view of the EX region of FIG. 5.

Hereinafter, features are described with reference to FIGS. 2, 3, 4, 5, and 6.

Unless otherwise defined, a direction parallel with an upper surface of a package substrate 100 is defined as a first direction (X direction), a direction perpendicular to the upper surface of the package substrate 100 is defined as a vertical direction (Z direction), and a direction perpendicular to the first direction (X direction) and the vertical direction (Z direction) is defined as a second direction (Y direction). The first direction (X direction), the second direction (Y direction), and combinations of the two can be defined as horizontal directions.

The package substrate 100 of the semiconductor package 10 may be, for example, a printed circuit board (PCB). The package substrate 100 may include a core insulating layer including at least one material selected from phenol resin, epoxy resin, and polyimide. For example, the core insulating layer may include at least one material selected from polyimide, Flame Retardant 4 (FR-4), tetrafunctional epoxy, polyphenylene ether, epoxy/polyphenylene oxide, bismaleimide triazine (BT), thermount, cyanate ester, and liquid crystal polymer.

As illustrated in FIG. 4, the package substrate 100 may include an upper pad 170 arranged on an upper surface of the core insulating layer and a lower pad 180 arranged on a lower surface of the core insulating layer. The upper pad 170 and the lower pad 180 may each be a part of a circuit wiring patterned after a Cu foil is coated on the upper surface and the lower surface of the core insulating layer. For example, the upper pad 170 and the lower pad 180 may each be an area of the circuit wiring, which is not coated by a solder-resist layer and exposed to the outside.

In some implementations, the upper pad 170 and the lower pad 180 may each include copper, nickel, stainless steel, or beryllium copper. An internal wiring electrically connected to the upper pad 170 and the lower pad 180 may be formed in the package substrate 100.

External connection terminals CT1 may be attached to the lower pad 180. The external connection terminals CT1 may electrically and physically connect the package substrate 100 to an external device on which the package substrate 100 is mounted. The external connection terminals CT1 may include, for example, a solder ball or a solder bump.

As illustrated in FIG. 5, a photonic integrated circuit (PIC) chip 200 of the semiconductor package 10 may be arranged on the package substrate 100. In some implementations, the PIC chip 200 may be arranged in an edge area of the upper surface of the package substrate 100, and a semiconductor chip 500 may be arranged in a central area of the upper surface of the package substrate 100.

In some implementations, the semiconductor package 10 may include a plurality of PIC chips 200, and the plurality of PIC chips 200 may be arranged in a line along one or more sides (e.g., each side) of the upper surface of the package substrate 100. Although FIG. 2 illustrates that four PIC chips 200 are arranged along each side of the upper surface of the package substrate 100, the number of PIC chips 200 is not limited thereto.

The PIC chip 200 of the semiconductor package 10 may input or output an optical signal. For example, the PIC chip 200 may transmit an optical signal to an optical fiber 320 by converting an electric signal into an optical signal, and may transmit an electric signal to an electronic integrated circuit (EIC) chip 400 by converting an optical signal transmitted from the optical fiber 320 into an electric signal.

The PIC chip 200 may include a first substrate 210, a first wiring structure 230, a photoelectric converter 600, and a first through via 215.

The first substrate 210 may include a semiconductor material such as silicon (Si). In some implementations, the first substrate 210 may include a semiconductor material, such as germanium (Ge).

The first substrate 210 may include an active surface 211 where a plurality of individual devices are formed, and an inactive surface opposite the active surface 211. The first wiring structure 230 may be formed on the active surface 211 of the first substrate 210. The first through via 215 may extend from the inactive surface of the first substrate 210 to the active surface 211. In some implementations, the first through via 215 may be electrically connected to the first wiring structure 230 and/or the plurality of individual devices on the active surface 211.

The PIC chip 200 may be arranged on the package substrate 100 such that the active surface 211 of the first substrate 210 of the PIC chip 200 faces the EIC chip 400. For example, the PIC chip 200 may be arranged to the package substrate 100 in a face-up manner. Herein, the active surface 211 of the first substrate 210 may be referred to as an upper surface of the first substrate 210, and the inactive surface of the first substrate 210 may be referred to as a lower surface of the first substrate 210. However, the relationship between the active surface 211 and the inactive surface and their corresponding directions is not limited thereto.

A groove 200_G of the PIC chip 200 may extend from a lateral surface 200S and an upper surface of the PIC chip 200 to the inside of the PIC chip 200. For example, the groove 200_G may be in contact with the upper surface and the lateral surface 200S of the PIC chip 200. For example, the groove 200_G may be in contact with one side of the upper surface of the PIC chip 200. For example, the first substrate 210 may not be present on the upper surface of the groove 200_G, and the inside of the groove 200_G may be exposed. Accordingly, the optical fiber 320 may have a length in the vertical direction which is greater than a length of the groove 200_G in the vertical direction (Z direction).

In some implementations, the groove 200_G may be referred to as a V-groove. The cross-section of the groove 200_G in a direction perpendicular to an extension direction of the groove 200_G (e.g., the view as shown in FIG. 4) may have a shape of V-shaped grooves partially overlapping along the lateral surface 200S of the PIC chip 200. For example, an optical fiber 320 may be mounted onto each of the V-shaped grooves.

Although FIG. 6 illustrates the photoelectric converter 600 buried in a first insulating layer 233, the arrangement of the photoelectric converter 600 is not limited thereto, and the photoelectric converter 600 may be covered with an oxide layer distinct from the first insulating layer 233. For example, the oxide layer may be formed on one side of the first insulating layer 233, and the photoelectric converter 600 may be arranged in the oxide layer.

The first wiring structure 230 of the PIC chip 200 may include a plurality of first wiring patterns 231, a plurality of first wiring vias 232 connected to the plurality of first wiring patterns 231, and the first insulating layer 233 surrounding the plurality of first wiring patterns 231 and the plurality of first wiring vias 232. In some implementations, the first wiring structure 230 may have a multi-layer wiring structure including the first wiring patterns 231 and the first wiring vias 232 which are placed at different vertical levels from each other.

In some implementations, the PIC chip 200 may further include a lower pad 280. The lower pad 280 may be arranged on the lower surface of the PIC chip 200 and may be electrically connected to the first through via 215.

In some implementations, the lower pad 280 of the PIC chip 200 may be electrically connected to the upper pad 170 of the package substrate 100 through a pad-buried layer 285. The PIC chip 200 and the package substrate 100 may be electrically connected through a non-conductive film or a direct combination. The pad-buried layer 285 may include, for example, an anisotropic conductive film (ACF) obtained by mixing conductive particles in thermosetting resin or an under-fill material. The under-fill material may include, for example, liquid epoxy resin, ring-shaped carbonate-terminated oligomer, and a hardener. In some implementations, the pad-buried layer 285 may include FR-4, tetrafunctional epoxy, polyphenylene ether, epoxy/polyphenylene oxide, BT, thermount, cyanate ester, polyimide, or a combination thereof. The materials that may be included in the pad-buried layer 285 are not limited to the foregoing.

A vertical level 200_VL of the lower surface of the PIC chip 200 may be lower than a vertical level 500_VL of the lower surface of the semiconductor chip 500. The lower pad 280 of the PIC chip 200 may be in direct contact with the upper pad 170 of the package substrate 100, and a lower pad 580 of the semiconductor chip 500 may be spaced apart from the upper pad 170 of the package substrate 100 with a connection terminal CT5 arranged therebetween. Accordingly, the vertical level 200_VL of the lower surface of the PIC chip 200 may be lower than the vertical level 500_VL of the lower surface of the package substrate 100 by a length of the connection terminal CT5 in the vertical direction (Z direction).

In some implementations, the PIC chip 200 may further include an upper pad 270. The upper pad 270 may be arranged on the upper surface of the first wiring structure 230 of the PIC chip 200 and may be electrically connected to the plurality of first wiring patterns 231 and/or the plurality of first wiring vias 232.

The EIC chip 400 of a semiconductor package 1000 may be arranged on the PIC chip 200. The EIC chip 400 may be spaced apart from the package substrate 100 with the PIC chip 200 arranged therebetween.

The EIC chip 400 may include a second substrate 410 and a second wiring structure 430. The second substrate 410 of the EIC chip 400 may include an active surface 411 and an inactive surface opposite the active surface 411. The second wiring structure 430 may be formed on the active surface 411 of the second substrate 410.

In some implementations, the EIC chip 400 may be arranged on the PIC chip 200 such that the active surface 411 of the second substrate 410 faces the PIC chip 200. For example, the EIC chip 400 may be arranged on the PIC chip 200 in a face-down manner.

The second substrate 410 may include a semiconductor material such as Si. In some implementations, the second substrate 410 may include a semiconductor material, such as Ge.

In some implementations, the EIC chip 400 may include a plurality of individual devices used for interfacing with other individual devices by the PIC chip 200. The plurality of individual devices of the EIC chip 400 may be arranged on the active surface 411 of the second substrate 410. For example, the EIC chip 400 may include CMOS drivers, trans-impedance amplifiers, etc., to perform functions, such as control of high-frequency signaling of the PIC chip 200.

The second wiring structure 430 of the EIC chip 400 may include a plurality of second wiring patterns 431, a plurality of second wiring vias 432 connected to the plurality of second wiring patterns 431, and a second insulating layer 433 surrounding the plurality of second wiring patterns 431 and the plurality of second wiring vias 432. In some implementations, the second wiring structure 430 may have a multi-layer wiring structure including the second wiring patterns 431 and the second wiring vias 432 which are placed at different vertical levels from each other.

In some implementations, the EIC chip 400 may further include a lower pad 480. The lower pad 480 may be arranged on the lower surface of the EIC chip 400 and may be electrically connected to the second wiring patterns 431 and/or the second wiring vias 432.

In some implementations, the lower pad 480 of the EIC chip 400 may be electrically connected to the upper pad 270 of the PIC chip 200 through a connection terminal CT4. The connection between the EIC chip 400 and the PIC chip 200 is not limited thereto.

The semiconductor chip 500 of the semiconductor package 1000 may be arranged on the package substrate 100. In some implementations, the semiconductor chip 500 may be spaced apart from the PIC chip 200 in a horizontal direction and may be in a central area of the package substrate 100.

The semiconductor chip 500 may include an active surface and an inactive surface opposite the active surface. In some implementations, the semiconductor chip 500 may include an application specific integrated circuit (ASIC).

In some implementations, the semiconductor chip 500 may be mounted on the package substrate 100 in such a manner that the active surface faces down. In some implementations, the lower pad 580 of the semiconductor chip 500 may be electrically connected to the upper pad 170 of the package substrate 100 through the connection terminal CT5. The connection between the semiconductor chip 500 and the package substrate 100 is not limited thereto.

In some implementations, various individual devices may be arranged on the active surface of the semiconductor chip 500. The plurality of individual devices may include various microelectronic devices, for example, a complementary metal-oxide-semiconductor (CMOS) transistor, a metal-oxide-semiconductor field effect transistor (MOSFET), a system large scale integration (LSI), an image sensor, such as a CMOS imaging sensor (CIS), etc., a micro-electro-mechanical system (MEMS), an active element, a passive element, etc.

The optical fiber unit 300 of the semiconductor package 10 may include a frame 310 and at least one optical fiber 320. The frame 310 of the optical fiber unit 300 may be arranged in an outer area of the package substrate 100. For example, the frame 310 may be spaced apart from the lateral surface of the package substrate 100 in the horizontal direction.

In some implementations, the optical fiber 320 may extend from one surface of the frame 310 towards the PIC chip 200 and the package substrate 100. The one surface of the frame 310 may face the groove 200_G of the PIC chip 200. That is, the one surface of the frame 310 may face a lateral surface in which the groove 200_G is arranged, among the lateral surfaces 200S of the PIC chip 200.

The optical fiber 320 may pass through the frame 310 and may be mounted in the groove 200_G of the PIC chip 200. For example, the optical fiber 320 may be fixed inside the groove 200_G by a clamping lead 340 arranged on the optical fiber 320. For example, the clamping lead 340 may be a celling of the groove 200_G. In some implementations, an empty space between the optical fiber 320 and the groove 200_G may be filled with a transparent epoxy material.

The optical fiber 320 may include a core layer 321 and a clad layer 322 surrounding the core layer 321. The core layer 321 may have a relatively high refractive index, and the clad layer 322 may have a relatively low refractive index. An optical signal incident onto the core layer 321 may travel along the core layer 321 which has a high refractive index. An optical signal OS travelling from the core layer 321 to the clad layer 322 may be total-reflected and proceed along the core layer 321 based on the refractive index difference between the core layer 321 and the clad layer 322.

In some implementations, the optical fiber unit 300 may include a plurality of optical fibers 320. The plurality of optical fibers 320 may input/output optical signals having different wavelengths from each other. The plurality of optical fibers 320 may emit an optical signal to different edge couplers 602 and 603. The plurality of optical fibers 320 may emit an optical signal to the plurality of edge couplers 602 and 603 having substantially the same cross-section shape. The edge couplers 602 and 603 disclosed in the specification may include a transmitter edge coupler 602 and a receiver edge coupler 603.

In some implementations, the optical fiber 320 may input/output an optical signal having multiple wavelengths (sometimes referred to as “multi-wavelengths”). For example, the optical signal emitted from the optical fiber 320 may have a plurality of peak wavelengths. The optical fiber 320 may emit an optical signal having multi-wavelengths to one edge coupler (602 or 603).

The optical fiber 320 of the semiconductor package 10 may emit an optical signal having multi-wavelengths, and the photoelectric converter 600 of the PIC chip 200 may transmit/receive the optical signal having multi-wavelengths. Accordingly, the semiconductor package 10 may have a relatively wide bandwidth.

A vertical level 321_VL of the core layer 321 of the optical fiber 320 at one end of the optical fiber 320 facing the edge couplers 602 and 603 may be identical to vertical levels 602_VL and 603_VL of the edge couplers 602 and 603. The optical fiber 320 may be mounted onto the groove 200_G such that the center of the core layer 321 and the center of the edge couplers 602 and 603 are arranged in a horizontal line. In some implementations, the vertical level 321_VL of the core layer 321 of the optical fiber 320 at one end of the optical fiber 320 facing the edge couplers 602 and 603 may be different from the vertical levels 602_VL and 603_VL of the edge couplers 602 and 603 by 1 μm or less. For example, in the process of mounting the optical fiber 320 onto the PIC chip 200, the error in the vertical direction (Z direction) may be reduced to 1 μm or less.

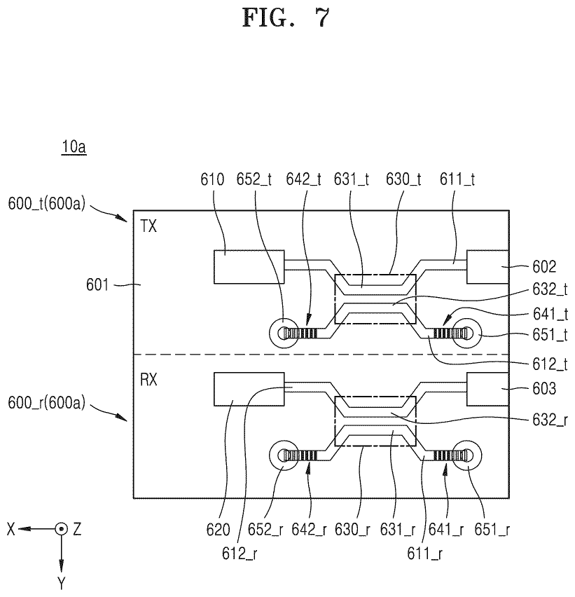

FIG. 7 is a plan view schematically illustrating a photoelectric converter 600a according to some implementations. A semiconductor package 10a and the photoelectric converter 600a illustrated in FIG. 7 are respectively an example of the semiconductor package 10 and the photoelectric converter 600 illustrated in FIGS. 2 to 6, and can have the same characteristics except where noted otherwise.

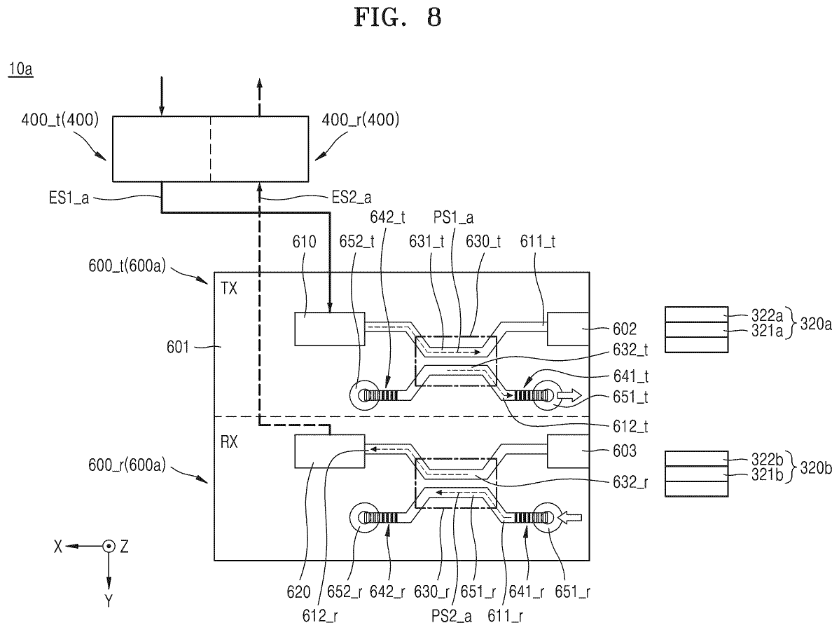

The photoelectric converter 600a according to some implementations may include a PIC transmitter 600_t and a PIC receiver 600_r. The PIC transmitter 600_t may convert an electric signal transmitted from an EIC transmitter 400_t (see FIG. 8) of the EIC chip 400 into an optical signal and output the optical signal to the outside. In addition, the PIC receiver 600_r may convert an optical signal input from the outside into an electric signal and transmit the electric signal to an EIC receiver 400_r of the EIC chip 400.

In some implementations, the PIC transmitter 600_t may include the transmitter edge coupler 602, a light-emitting device 610, a first transmitter grating coupler 641_t, a second transmitter grating coupler 642_t, a transmitter tunable coupler 630_t, a first waveguide 611_t, and a second waveguide 612_t. The PIC receiver 600_r may include the receiver edge coupler 603, a first receiver grating coupler 641_r, a second receiver grating coupler 642_r, a photodiode 620 (or other photodetector device), a receiver tunable coupler 630_r, a third waveguide 611_r, and a fourth waveguide 612_r.

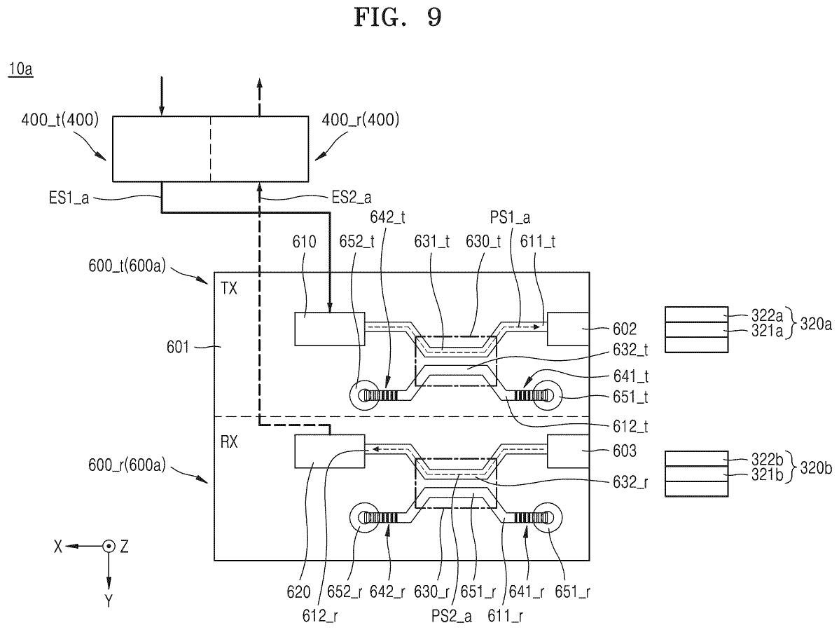

The transmitter edge coupler 602 may be arranged on the lateral portion of the photoelectric converter 600a. The transmitter edge coupler 602 may function as an entrance for an optical signal in the PIC transmitter 600_t. For example, the transmitter edge coupler 602 may couple the optical signal received from the first waveguide 611_t with an optical fiber facing the transmitter edge coupler 602 (e.g., a first optical fiber 320a as shown in FIG. 9).

One end of the first waveguide 611_t may be connected to the light-emitting device 610, and the other end opposite to the one end may be connected to the transmitter edge coupler 602. The first waveguide 611_t may extend from the light-emitting device 610 in the first horizontal direction (X direction) and be bent at an oblique angle from the first horizontal direction (X direction). After being bent at an oblique angle from the first horizontal direction (X direction), the first waveguide 611_t may extend in the first horizontal direction (X direction) once again. For example, the first waveguide 611_t may include brass, copper, silver, aluminum, or a metal material having low electrical resistance. However, the scope of this disclosure is not limited thereto, and the first waveguide 611_t may include silicon. The waveguides disclosed in the specification may be configured to guide an optical signal.

The light-emitting device 610 may be connected to the first waveguide 611_t. The light-emitting device 610 may convert an electric signal into an optical signal. For example, the light-emitting device 610 may include an optical modulator. However, according to some implementations, the light-emitting device 610 may also include a device configured to generate and emit an optical signal, in addition to a device configured to convert an electric signal into an optical signal. In this case, the light-emitting device 610 may include a laser.

The second waveguide 612_t may be arranged apart from the first waveguide 611_t in the second horizontal direction (Y direction). In some implementations, the second waveguide 612_t may have a mirror-symmetrical shape with respect to the first waveguide 611_t in the first horizontal direction (X direction). The shape of the second waveguide 612_t is not limited thereto, and the second waveguide 612_t may have an asymmetrical shape with respect to the first waveguide 611_t. Materials included in the second waveguide 612_t may be identical to the materials included in the first waveguide 611_t.

One end of the second waveguide 612_t may be connected to the first transmitter grating coupler 641_t, and the other end opposite to the one end may be connected to the second transmitter grating coupler 642_t. In addition, a first transmitter optical fiber 651_t may be arranged to overlap with (e.g., share a common vertical level with) and face the first transmitter grating coupler 641_t in the vertical direction (Z direction), and a second transmitter optical fiber 652_t may be arranged to overlap with (e.g., share a common vertical level with) and face the second transmitter grating coupler 642_t in the vertical direction (Z direction). The first transmitter grating coupler 641_t and the second transmitter grating coupler 642_t may function as an entrance for an optical signal in the PIC transmitter 600_t. For example, the first transmitter grating coupler 641_t may couple the optical signal received from the second waveguide 612_t to the first transmitter optical fiber 651_t, and the second transmitter grating coupler 642_t may couple the optical signal received from the second transmitter optical fiber 652_t to the second waveguide 612_t.

In some implementations, in the first transmitter grating coupler 641_t and the second transmitter grating coupler 642_t, a plurality of grooves, floors, etc., functioning as/forming a diffraction grating which facilitates diffraction of light may be arranged at regular intervals.

The transmitter tunable coupler 630_t may be connected to the first waveguide 611_t and the second waveguide 612_t. For example, the transmitter tunable coupler 630_t may include a first portion 631_t integrated with the first waveguide 611_t and a second portion 632_t integrated with the second waveguide 612_t. The first portion 631_t and the second portion 632_t may be spaced apart from each other in the second horizontal direction (Y direction). The transmitter tunable coupler 630_t may couple some of optical signals passing through the first waveguide 611_t to the second waveguide 612_t. Optical signals coupled from the first waveguide 611_t to the second waveguide 612_t may be affected by a distance between the first portion 631_t and the second portion 632_t in the second horizontal direction (Y direction).

The receiver edge coupler 603 may be arranged on the lateral portion of the photoelectric converter 600a. The receiver edge coupler 603 may function as an entrance for an optical signal in the PIC receiver 600_r. For example, the receiver edge coupler 603 may couple the optical signal received from a second optical fiber 320b (see FIG. 9) facing the receiver edge coupler 603 to the fourth waveguide 612_r.

One end of the third waveguide 611_r may be connected to the first receiver grating coupler 641_r, and the other end opposite to the one end may be connected to the second receiver grating coupler 642_r. In addition, a first receiver optical fiber 651_r may be arranged to overlap with and face the first receiver grating coupler 641_r in the vertical direction (Z direction), and a second receiver optical fiber 652_r may be arranged to overlap with and face the second receiver grating coupler 642_r in the vertical direction (Z direction). The first receiver grating coupler 641_r and the second receiver grating coupler 642_r may function as an entrance for an optical signal in the PIC receiver 600_r. For example, the first receiver grating coupler 641_r may couple the optical signal received from the first receiver optical fiber 651_r to the third waveguide 611_r, and the second receiver grating coupler 642_r may couple the optical signal from the third waveguide 611_r to the second receiver optical fiber 652_r.

In some implementations, in the first receiver grating coupler 641_r and the second receiver grating coupler 642_r, a plurality of grooves, floors, etc., functioning as/forming a diffraction grating which facilitates diffraction of light may be arranged at regular intervals. The first receiver grating coupler 641_r and the second receiver grating coupler 642_r may be substantially identical to the first receiver grating coupler 641_r and the second receiver grating coupler 642_r, respectively.

The receiver tunable coupler 630_r may be connected to the third waveguide 611_r and the fourth waveguide 612_r. For example, the receiver tunable coupler 630_r may include a third portion 631_r integrated with the third waveguide 611_r and a fourth portion 632_r integrated with the fourth waveguide 612_r. The third portion 631_r and the fourth portion 632_r may be spaced apart from each other in the second horizontal direction (Y direction). The receiver tunable coupler 630_r may couple some of optical signals passing through the third waveguide 611_r to the fourth waveguide 612_r. Optical signals coupled from the third waveguide 611_r to the fourth waveguide 612_r may be affected by the distance between the third portion 631_r and the fourth portion 632_r in the second horizontal direction (Y direction).

One end of the fourth waveguide 612_r may be connected to the photodiode 620 (or other type of photodetector), and the other end opposite to the one end may be connected to the receiver edge coupler 603. The fourth waveguide 612_r may extend from the photodiode 620 in the first horizontal direction (X direction) and be bent at an oblique angle from the first horizontal direction (X direction). After being bent at an oblique angle from the first horizontal direction (X direction), the fourth waveguide 612_r may extend in the first horizontal direction (X direction) once again. Materials included in the third waveguide 611_r and the fourth waveguide 612_r may be substantially identical to the materials included in the first waveguide 611_t and the second waveguide 612_t.

The photodiode 620 may be connected to the fourth waveguide 612_r. The photodiode 620 may convert an optical signal into an electric signal.

The fourth waveguide 612_r may be arranged apart from the third waveguide 611_r in the second horizontal direction (Y direction). In some implementations, the fourth waveguide 612_r may have a mirror-symmetrical shape with respect to the third waveguide 611_r in the first horizontal direction (X direction). The shape of the fourth waveguide 612_r is not limited thereto, and the fourth waveguide 612_r may have an asymmetrical shape with respect to the third waveguide 611_r.

FIGS. 8 and 9 are each a diagram schematically illustrating an operating process of the photoelectric converter 600a. For example, FIG. 8 may schematically illustrate an operating process of the photoelectric converter 600a in a test process.

Referring to FIG. 8, the EIC chip 400 may include an EIC transmitter 400t and an EIC receiver 400_r. The EIC transmitter 400t may transmit a first electric signal ES1_a input from the outside of the EIC chip 400 to the light-emitting device 610 of the PIC transmitter 600_t. The EIC receiver 400_r may output a second electric signal ES2_a received from the photoelectric converter 600a to the outside.

The EIC transmitter 400t may transmit the first electric signal ES1_a input from the outside of the EIC chip 400 to the light-emitting device 610 of the PIC transmitter 600_t. For example, the light-emitting device 610 may include an optical modulator or a laser. The first electric signal ES1_a received from the EIC transmitter 400t may be an analog electric signal having a value (e.g., intensity) that varies continuously according to frequency. The light-emitting device 610 may convert the first electric signal ES1_a into a first optical signal PS1_a. For example, the light-emitting device 610 may convert the first electric signal ES1_a into an optical signal having a particular frequency or a continuous wave laser signal as an input optical signal based on a phase of the first electric signal ES1_a. Then, the first optical signal PS1_a may move along the first waveguide 611_t. The first waveguide 611_t may function as a channel transmitting the first optical signal PS1_a without loss or with negligible loss.

The transmitter tunable coupler 630_t connected to the first waveguide 611_t and the second waveguide 612_t may couple the first optical signal PS1_a passing through the first waveguide 611_t to the first optical signal PS1_a passing through the second waveguide 612_t. The coupled first optical signal PS1_a may move along the second waveguide 612_t. The transmitter tunable coupler 630_t may control division of the first optical signal PS1_a based on a conversion parameter, etc. For example, the conversion parameter may include an optical signal wavelength, a coupling ratio, etc.

One end of the second waveguide 612_t may be connected to the first transmitter grating coupler 641_t. The first transmitter grating coupler 641_t may couple the first optical signal PS1_a passing through the second waveguide 612_t to an optical beam which may pass through free space. In the first transmitter grating coupler 641_t, a plurality of grooves, floors, etc. functioning as a diffraction grating which facilitates diffraction of light may be arranged at regular intervals. The first optical signal PS1_a coupled to the optical beam may be output to the outside of the photoelectric converter 600a through the first transmitter optical fiber 651_t overlapping with the first transmitter grating coupler 641_t in the vertical direction (Z direction).

Even when the optical fiber is not arranged to face the transmitter edge coupler 603 through a series of processes described above, in the test process, the first electric signal ES1_a input through the EIC transmitter 400t may be tested as to whether the first electric signal ES1_a is converted into the first optical signal PS1_a and output through the PIC transmitter 600_t.

Hereinafter, a process in which a second optical signal PS2_a input through the PIC receiver 600_r is converted into the second electric signal ES2_a and output through the EIC receiver 400_r during the test process is described.

First, in the PIC receiver 600_r, the second optical signal PS2_a input from the outside of the photoelectric converter 600a may be transmitted to the photodiode 620. The first receiver optical fiber 651_r may overlap with (e.g., share a common vertical level with) the first receiver grating coupler 641_r connected to the third waveguide 611_r. The first receiver optical fiber 651_r may emit an optical beam towards the first receiver grating coupler 641_r. Similar to the first transmitter grating coupler 641_t, the first receiver grating coupler 641_r may have a structure which facilitates diffraction of light. The first transmitter grating coupler 641_t may couple an optical beam which may pass through free space to the second optical signal PS2_a which may pass through the second waveguide 612_t.

The receiver tunable coupler 630_r connected to the third waveguide 611_r and the fourth waveguide 612_r may couple the second optical signal PS2_a passing through the third waveguide 611_r to the second optical signal PS2_a passing through the fourth waveguide 612_r. The coupled second optical signal PS2_a may move along the fourth waveguide 612_r. The receiver tunable coupler 630_r may have substantially the same structure as the transmitter tunable coupler 630_t.

The photodiode 620 connected to the fourth waveguide 612_r may convert the second optical signal PS2_a into the second electric signal ES2_a. Then, the second electric signal ES2_a may be transmitted to the EIC receiver 400_r, and the EIC receiver 400_r may output the second electric signal ES2_a to the outside of the EIC chip 400.

Even when the optical fiber is not arranged to face receiver edge coupler 603 through a series of processes described above, in the test process, the second optical signal PS2_a input through the PIC receiver 600_r may be tested as to whether the second optical signal PS2_a is converted into the second electric signal ES2_a and output through the EIC receiver 400_r.

Hereinafter, an operation of outputting an optical signal through the transmitter edge coupler 603 and an operation of inputting an optical signal through the receiver edge coupler 603 are described with reference to FIG. 9.

The operation of the semiconductor package 10a illustrated in FIG. 9 may be an operation in the case where a plurality of optical fibers 320a and 320b are arranged in the semiconductor package 10a separated from the wafer W.

In some implementations, the EIC transmitter 400t may transmit the first electric signal ES1_a input from the outside of the EIC chip 400 to the light-emitting device 610 of the PIC transmitter 600_t. The light-emitting device 610 may convert the first electric signal ES1_a into the first optical signal PS1_a, and the first optical signal PS1_a may move along the first waveguide 611_t. However, unlike the configuration of the transmitter tunable coupler 630_t illustrated in FIG. 8, the transmitter tunable coupler 630_t illustrated in FIG. 9 may be configured to not couple, or may only minimally or negligibly couple, the first optical signal PS1_a to the second waveguide 612_t. Accordingly, the first optical signal PS1_a may be mostly directed to the transmitter edge coupler 603 along the first waveguide 611_t.

In some implementations, the transmitter edge coupler 602 may couple the first optical signal PS1_a passing through the first waveguide 611_t to an optical beam which may pass through free space. The first optical signal PS1_a coupled to the optical beam may be output to the outside of the photoelectric converter 600a through the first optical fiber 320a facing the transmitter edge coupler 603.

Similarly, in the PIC receiver 600_r, the second optical signal PS2_a may be input from the outside of the photoelectric converter 600a. Unlike the configuration of the PIC receiver 600_r illustrated in FIG. 8, the second optical signal PS2_a may be input through the receiver edge coupler 603, as opposed to the first receiver grating coupler 641_r. The receiver edge coupler 603 may couple an optical beam which may pass through free space to the second optical signal PS2_a. Then, the second optical signal PS2_a may be transmitted to the photodiode 620 through the third waveguide 611_r connected to the receiver edge coupler 603. However, unlike the configuration of the receiver tunable coupler 630_r illustrated in FIG. 8, the receiver tunable coupler 630_r illustrated in FIG. 9 may be configured to not couple, or minimally or negligibly couple, the second optical signal PS2_a to the fourth waveguide 612_r. Accordingly, the second optical signal PS2_a may be mostly directed to the photodiode 620 along the third waveguide 611_r.

Then, in the photodiode 620, the second optical signal PS2_a may be converted into the second electric signal ES2_a, and the second electric signal ES2_a may be transmitted to the EIC receiver 400_r. The EIC receiver 400_r may output the second electric signal ES2_a to the outside of the EIC chip 400.

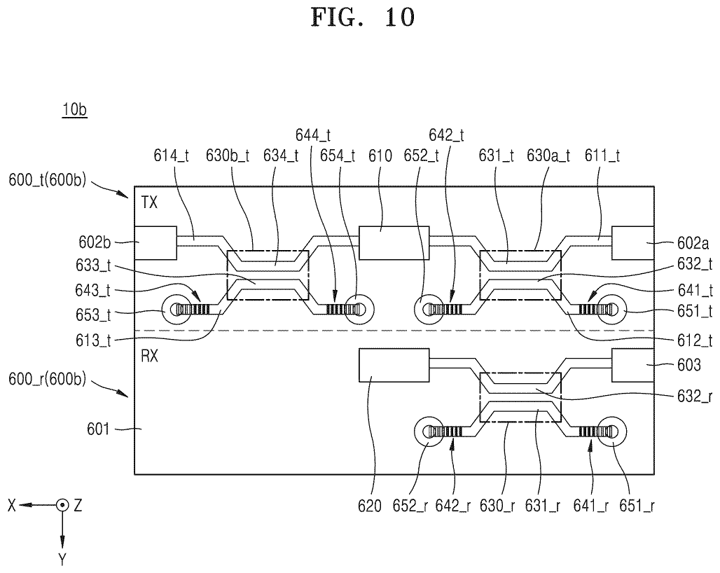

FIG. 10 is a plan view schematically illustrating a photoelectric converter 600b according to some implementations. Hereinafter, implementations are described focusing on the differences from the photoelectric converter 600a illustrated in FIG. 7; the photoelectric converter 600b can have the characteristics described for the photoelectric converter 600a except where noted otherwise. A semiconductor package 10b and the photoelectric converter 600b illustrated in FIG. 10 are respectively an example of the semiconductor package 10 and the photoelectric converter 600 illustrated in FIGS. 2 to 6 and can have the same characteristics except where noted otherwise.

The photoelectric converter 600b illustrated in FIG. 10 may include a second transmitter edge coupler 602b, third and fourth transmitter waveguides 613_t and 614_t, a second transmitter tunable coupler 630b_t, third and fourth transmitter grating couplers 643_t and 644_t, and third and fourth transmitter optical fibers 653_t and 654_t.

The photoelectric converter 600b may include the PIC transmitter 600_t and the PIC receiver 600_r. One side of the light-emitting device 610 of the PIC transmitter 600_t may be connected to the first waveguide 611_t, and another end of the light-emitting device 610 may be connected to a sixth waveguide 614_t. One end of the sixth waveguide 614_t may be connected to the light-emitting device 610, and the other end opposite to the one end may be connected to a second transmitter edge coupler 602b.

The second transmitter edge coupler 602b may be arranged on the lateral portion of the photoelectric converter 600b. The lateral portion of the photoelectric converter 600b on which the second transmitter edge coupler 602b is arranged may be opposite to the lateral portion on which the first transmitter edge coupler 603 is arranged; however, the arrangement is not limited thereto. Similar to the first transmitter edge coupler 603, the second transmitter edge coupler 602b may function as an entrance for an optical signal in the PIC transmitter 600_t.

The sixth waveguide 614_t may be arranged spaced apart from a fifth waveguide 613_t in the second horizontal direction (Y direction). One end of the fifth waveguide 613_t may be connected to the third transmitter grating coupler 643_t, and the other end opposite to the one end may be connected to the fourth transmitter grating coupler 644_t. In addition, a third transmitter optical fiber 653_t may be arranged to overlap with (e.g., share a common vertical level with) and face the third transmitter grating coupler 643_t in the vertical direction (Z direction), and a fourth transmitter optical fiber 654_t may be arranged to overlap with (e.g., share a common vertical level with) and face the fourth transmitter grating coupler 644_t in the vertical direction (Z direction). Similar to the first transmitter grating coupler 641_t and the second transmitter grating coupler 642_t, the third transmitter grating coupler 643_t and the fourth transmitter grating coupler 644_t may function as an entrance for an optical signal in the PIC transmitter 600_t.

The second transmitter tunable coupler 630b_t may be connected to the fifth waveguide 613_t and the sixth waveguide 614_t. For example, the second transmitter tunable coupler 630b_t may include a fifth portion 633_t integrated with the fifth waveguide 613_t and a sixth portion 634_t integrated with the sixth waveguide 614_t. The fifth portion 633_t and the sixth portion 634_t may be apart from each other in the second horizontal direction (Y direction). The second transmitter tunable coupler 630b_t may couple some of optical signals passing through the fifth waveguide 613_t to the sixth waveguide 614_t. Also, some of optical signals passing through the fifth waveguide 613_t may be coupled to the sixth waveguide 614_t through the second transmitter tunable coupler 630b_t. The configuration and structure of the second transmitter tunable coupler 630b_t may be substantially the same as a first transmitter tunable coupler 630a_t.

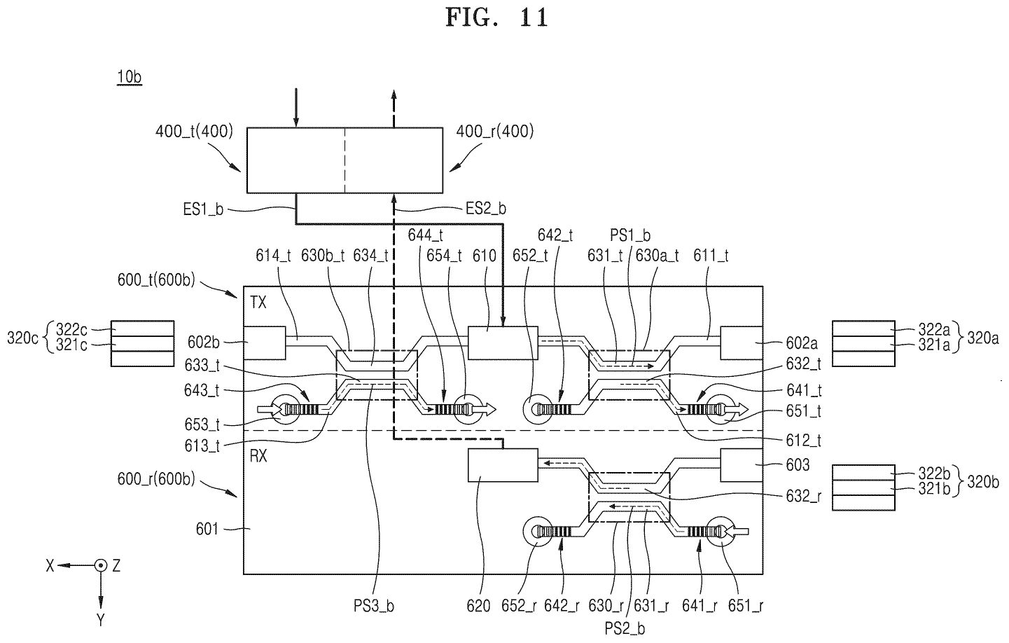

FIG. 11 is a diagram schematically illustrating an operating process of the photoelectric converter 600b. For example, FIG. 11 may schematically illustrate an operating process of the photoelectric converter 600b in a test process.

Aspects of the operating method of the photoelectric converter 600a which have already been described in relation to FIG. 8 are omitted and can be applied to the process of FIG. 112 except where noted otherwise. In some implementations, in the PIC receiver 600_r, a third optical signal PS3_b may be input from the outside of the photoelectric converter 600b. The third transmitter optical fiber 653_t overlapping with and facing the third transmitter grating coupler 643_t may emit an optical beam towards the third transmitter grating coupler 643_t. As the third transmitter grating coupler 643_t has a structure which facilitates diffraction of light, the optical beam may be coupled to the third optical signal PS3_b which may pass through the fifth waveguide 613_t.

The second transmitter tunable coupler 630b_t connected to the fifth waveguide 613_t and the sixth waveguide 614_t may couple a part of the third optical signal PS3_b passing through the fifth waveguide 613_t to the third optical signal PS3_b passing through the sixth waveguide 614_t. The coupled third optical signal PS3_b may move along the sixth waveguide 614_t.

The coupled third optical signal PS3_b may be directed to the light-emitting device 610. The third optical signal PS3_b directed towards the light-emitting device 610 may pass through the first waveguide 611_t. Then, traveling of the third optical signal PS3_b may be substantially the same as the traveling of the first optical signal PS1_a described above in relation to FIG. 8.

A part of the third optical signal PS3_b passing through the fifth waveguide 613_t may not be coupled by the second transmitter tunable coupler 630b_t and may proceed through the fifth waveguide 613_t. A part of the third optical signal PS3_b proceeding through the fifth waveguide 613_t may be directed towards the fourth transmitter grating coupler 644_t. Then, the third optical signal PS3_b may be output to the outside of the photoelectric converter 600b through the fourth transmitter optical fiber 654_t facing and overlapping with the fourth transmitter grating coupler 644_t in the vertical direction (Z direction).

As an optical signal passing through the fifth waveguide 613_t may be input/output through the third transmitter grating coupler 643_t and the fourth transmitter grating coupler 644_t, an optical fiber need not be arranged to face an edge coupler. Accordingly, in a test process, an optical fiber need not be arranged on a lateral portion of the photoelectric converter 600b, and a semiconductor package may be arranged on the wafer W in a more integrated manner to improve manufacturing efficiency (e.g., throughput and/or reliability).

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While some examples have been particularly shown and described, it will be understood that various changes in form and details may be made therein without departing from the spirit and scope of this disclosure.

What is claimed is:

1. A semiconductor package comprising:
a package substrate; and
a photonic integrated circuit chip arranged on the package substrate, wherein the photonic integrated circuit chip comprises
a groove extending from a lateral surface of the photonic integrated circuit chip toward an inside of the photonic integrated circuit chip, and
a photoelectric converter,
wherein the photoelectric converter comprises
a light-emitting device configured to generate an optical signal,
a first waveguide connected to the light-emitting device and providing a path through which the optical signal travels,
a first grating coupler configured to output the optical signal,
a second waveguide connected to the first grating coupler, and
a tunable coupler connected to the first waveguide and the second waveguide.

2. The semiconductor package of claim 1, wherein the tunable coupler comprises:
a first portion integrated with the first waveguide; and
a second portion integrated with the second waveguide, and
wherein the first portion and the second portion are spaced apart from each other in a lateral direction.

3. The semiconductor package of claim 1, wherein the photoelectric converter comprises an edge coupler arranged on a lateral portion of the photonic integrated circuit chip,
wherein a first end of the first waveguide is connected to the light-emitting device, and
wherein a second end of the first waveguide, opposite the first end, is connected to the edge coupler.

4. The semiconductor package of claim 3, further comprising an optical fiber unit arranged in the groove,
wherein the optical fiber unit faces the edge coupler.

5. The semiconductor package of claim 1, further comprising an optical fiber facing and at a common vertical level with the first grating coupler.

6. The semiconductor package of claim 1, wherein the photoelectric converter comprises a second grating coupler connected to the second waveguide,
wherein a first end of the second waveguide is connected to the first grating coupler, and
wherein a second end of the second waveguide, opposite the first end, is connected to the second grating coupler.

7. The semiconductor package of claim 1, further comprising an electronic integrated circuit chip arranged on the photonic integrated circuit chip,
wherein the electronic integrated circuit chip is configured to transmit electrical signals to the light-emitting device.

8. The semiconductor package of claim 7, wherein the electronic integrated circuit chip includes at least one of a complementary metal-oxide-semiconductor (CMOS) driver or a trans-impedance amplifier.

9. The semiconductor package of claim 7, wherein the photonic integrated circuit chip comprises a through via, and wherein the photonic integrated circuit chip and the electronic integrated circuit chip are electrically connected to each other through the through via.

10. The semiconductor package of claim 1, wherein the light-emitting device includes a laser or an optical modulator.

11. A semiconductor package comprising:
a package substrate; and
a photonic integrated circuit chip arranged on the package substrate, wherein the photonic integrated circuit chip comprises
a groove extending from a lateral surface of the photonic integrated circuit chip toward an inside of the photonic integrated circuit chip, and
a photoelectric converter including a photonic integrated circuit (PIC) transmitter and a PIC receiver,
wherein the PIC transmitter comprises
a transmitter edge coupler arranged on a lateral portion of the photonic integrated circuit chip,
a light-emitting device configured to convert a first electrical signal into a first optical signal,
a transmitter grating coupler configured to output the first optical signal, and
a transmitter tunable coupler configured to couple to the first optical signal received from the light-emitting device and to transmit the coupled first optical signal to the transmitter grating coupler, and
wherein the PIC receiver comprises
a receiver edge coupler arranged on the lateral portion of the photonic integrated circuit chip,
a receiver grating coupler configured to input a second optical signal,
a photodetector configured to convert the second optical signal into a second electrical signal, and
a receiver tunable coupler configured to couple to the second optical signal received from the receiver grating coupler and transmit the coupled second optical signal to the photodetector.

12. The semiconductor package of claim 11, further comprising an electronic integrated circuit chip arranged on the photonic integrated circuit chip,
wherein the photodetector is configured to transmit the second electrical signal to the electronic integrated circuit chip.

13. The semiconductor package of claim 12, wherein the electronic integrated circuit chip includes a CMOS driver configured to transmit the first electrical signal to the light-emitting device.

14. The semiconductor package of claim 11, wherein the PIC transmitter includes a first waveguide and a second waveguide, and
wherein a first end of the first waveguide is connected to the light-emitting device, a second end of the first waveguide, opposite to the first end of the first waveguide, is connected to the transmitter edge coupler, and a first end of the second waveguide is connected to the transmitter grating coupler.

15. The semiconductor package of claim 11, wherein the PIC receiver includes a third waveguide and a fourth waveguide, and
wherein a first end of the third waveguide is connected to the photodetector, a second end of the third waveguide, opposite to the first end of the third waveguide, is connected to the receiver edge coupler, and a first end of the fourth waveguide is connected to the receiver grating coupler.

16. The semiconductor package of claim 11, further comprising an optical fiber unit arranged in the groove,
wherein the optical fiber unit faces the transmitter edge coupler.

17. The semiconductor package of claim 11, further comprising a first optical fiber and a second optical fiber,
wherein the first optical fiber and the transmitter grating coupler share a first common vertical level, and the second optical fiber and the receiver grating coupler share a second d 17ical level.

18. A semiconductor package comprising:
a package substrate; and
a photonic integrated circuit chip arranged on the package substrate, wherein the photonic integrated circuit chip comprises
a groove extending from a lateral surface of the photonic integrated circuit chip toward an inside of the photonic integrated circuit chip, and
a photoelectric converter including a photonic integrated circuit (PIC) transmitter and a PIC receiver,
wherein the PIC transmitter comprises
a light-emitting device configured to convert a first electrical signal into a first optical signal,
a first waveguide connected to the light-emitting device and providing a path through which the first optical signal travels,
a first transmitter grating coupler configured to output the first optical signal,
a second waveguide including a first end connected to the first transmitter grating coupler, and
a transmitter tunable coupler configured to couple to the first optical signal received from the first waveguide and transmit the coupled first optical signal to the second waveguide, and
wherein the PIC receiver comprises
a first receiver grating coupler configured to input a second optical signal,
a third waveguide including a second end connected to the first receiver grating coupler and providing a path through which the second optical signal travels,
a photodetector configured to convert the second optical signal into a second electrical signal,
a fourth waveguide connected to the photodetector and providing a path through which the second optical signal travels, and
a receiver tunable coupler configured to couple the second optical signal received from the third waveguide and transmit the coupled second optical signal to the fourth waveguide.

19. The semiconductor package of claim 18, further comprising an electronic integrated circuit (EIC) chip arranged on the photonic integrated circuit chip, the EIC chip including an EIC transmitter and an EIC receiver,
wherein the EIC transmitter is configured to transmit the first electrical signal to the light-emitting device, and
wherein the EIC receiver is configured to receive the second electrical signal from the photodetector.

20. The semiconductor package of claim 18, wherein the PIC transmitter comprises a second transmitter grating coupler connected to an end of the second waveguide opposite that is to the first end of the second waveguide, and
wherein the PIC receiver comprises a second receiver grating coupler connected to an end of the third waveguide that is opposite to the second end of the second waveguide.
